(19) United States
(12) Patent Application Publication
(10) Pub. No.: US 2011/0302649 A1
(43) Pub. Date: Dec. 8, 2011

(54) SYSTEM FOR AND METHOD OF PROVIDING SECURE SIGN-IN ON A TOUCH SCREEN DEVICE

(75) Inventors: Mark FOSTER, Palo Alto, CA (US); Bradford Parker, Santa Clara, CA (US)

(73) Assignee: SKIFF, INC., NEW YORK, NY (US)

(21) Appl. No.: 12/792,251

(22) Filed: Jun. 2, 2010

(51) Int. Cl. G06F 7/04; G06F 21/00

(52) U.S. Cl. 726/19

(57) ABSTRACT

A system for and method of providing secure sign-in on a touch screen device that comprises an electronic device in accordance with exemplary embodiments may include receiving, from a user, password data in a first input format, determining that the password data is associated with a valid user by at least comparing the first input format of the password data to a second input format and comparing the password data to valid character element data, wherein the second input format is derived in accordance with one or more password format rules, and providing the valid user with access to one or more functions of the touch screen device.

### FIELD OF THE INVENTION

The present invention relates to secure sign-in, generally, and a system for and method of providing secure sign-in on a touch screen device, in particular.

### BACKGROUND INFORMATION

Generally, users may attempt to create secure passwords using keyboards or keypads coupled to electronic devices (e.g., computers, mobile phones) to prevent unauthorized access to the electronic devices. Such passwords may include a combination of numbers, symbols, and upper and lower case letters. The amount of unique passwords, however, may be limited by the finite number of unique combinations that are created using a finite number of letters (e.g., 26 letters in the English language), numbers (e.g., numbers 0-9), and symbols. The most secure passwords may include nonsensical combinations that, in many instances, are difficult to remember. Accordingly, the use of such nonsensical passwords may result in a substantial increase in users forgetting their passwords or writing their passwords at locations that are easily identifiable.

### BRIEF DESCRIPTION OF THE DRAWINGS

Purposes and scope of exemplary embodiments described below will be apparent from the following detailed description in conjunction with the appended drawings in which like reference characters are used to indicate like elements, and in which:

FIG. 1 illustrates a block diagram of a secure sign-in system according to an embodiment of the invention;

FIG. 2 illustrates exemplary modules of a touch screen secure sign-in system according to an embodiment of the invention;

FIG. 3A illustrates exemplary password data according to an embodiment of the invention;

FIG. 3B illustrates additional exemplary password data according to an embodiment of the invention;

FIG. 3C illustrates additional exemplary password data according to an embodiment of the invention;

FIG. 3D illustrates additional exemplary password data according to an embodiment of the invention;

FIG. 3E illustrates additional exemplary password data according to an embodiment of the invention; and

FIG. 4 is a flow chart illustrating a method of providing secure sign-in on a touch screen device according to an embodiment of the invention.

### SUMMARY OF EMBODIMENTS OF THE INVENTION

At least one exemplary embodiment may provide a method of providing secure sign-in on a touch screen device that includes an electronic device. This embodiment may include receiving, from a user, password data in a first input format, determining that the password data is associated with a valid user by at least comparing the first input format of the password data to a second input format and comparing the password data to valid character element data, wherein the second input format is derived in accordance with one or more password format rules, and providing the valid user with access to one or more functions of the touch screen device.

Another exemplary embodiment according to this invention may provide a system for providing secure sign-in on a touch screen device that includes an electronic device. This embodiment may include a password computing apparatus configured to receive, from a user, password data in a first input format and determine that the password data is associated with a valid user by at least comparing the first input format of the password data to a second input format, wherein the second input format is derived in accordance with one or more password format rules, a character element authentication computing apparatus configured to determine that the password data is associated with the valid user by comparing the password data to valid character element data, and a validation computing apparatus configured to provide the valid user with access to one or more functions of the touch screen device.

### DETAILED DESCRIPTION OF EMBODIMENTS OF THE INVENTION

Currently, unauthorized users may be prevented from gaining unauthorized access to electronic devices (e.g., computers, mobile phones, reader devices) using one or more security mechanisms. Such security mechanisms may include password protection features (e.g., features that allow access to an electronic device upon receipt of a valid password), time out features (e.g., features that prohibit access to an electronic device after a period of time), and identification features (e.g., features that allow access to an electronic device upon receipt of data that indicates the identity of a valid user). In many instances, the strength of traditional passwords may be limited by the finite number of unique combinations that are created using numbers, symbols, and upper and lower case letters. Accordingly, stronger and less memorable nonsensical passwords may be used. The use of such nonsensical passwords, however, may result in a substantial increase in the amount of time spent resetting passwords or the amount of times passwords are accessed by unauthorized individuals at locations that are easily identifiable.

Access to touch screen devices (e.g., electrophoretic display (EPD) devices) may be secured using a secure sign-in system. A secure sign-in system may couple a display device (e.g., an EPD device), a touch screen system, and a touch screen secure sign-in system such that password data (e.g., data that indicates a password associated with a valid user) is received and verified prior to allowing user access to one or more functions of the touch screen system. In one embodiment, password data may include character element data (e.g., password data in the form of a combination of characters, such as letters, numbers, and symbols), drawn element data (e.g., password data in the form of user drawn elements, such as a free-form element, an object element, and a signature element), or a combination of both. In another embodiment, password data may include character element data only.

During an initial sign-in stage, a user of the touch screen system may create a password by selecting an input format (e.g., an arrangement of character element data, drawn element data, or a combination of both) according to one or more password format rules. A password format rule may define a valid format for a password. For example, a first password format rule may define a valid format of a password as a drawn element portion (e.g., drawn element data that includes any, or a combination, of a free-form element, an object element, a signature element). In another example, a second password format rule may define a valid format of a password as a drawn element first portion and a character element second portion (e.g., character element data that includes any, or a combination, of letters, symbols, and numbers). In yet another example, a third password format rule may define a valid format of a password as a character element first portion and a drawn element second portion. In yet another example, a fourth password format rule may define a valid format of a password as a character element first portion, a drawn element second portion, and a character element third portion. In yet another example, a fifth password format rule may define a valid format of a password as a drawn element first portion, a character element second portion, and a drawn element third portion.

During the initial sign-in stage, the user may also create a valid password by inputting password data in accordance with the valid format. In one embodiment, valid password data may include valid character element data, valid drawn element data, or a combination of both.

Upon signing in to the touch screen system, a user may input password data in a particular input format. If, for example, the input format of the password data is not the same as the predefined valid format, the touch screen system (e.g., the secure sign-in system of a touch screen system) may output an authentication error message (e.g., “You Have Used The Wrong Password Format! Please Try Again!”). If, however, the input format of the password data is the same as the predefined valid format, the touch screen system may begin authentication techniques, recognition techniques, or a combination of both, to determine if the user is valid. Accordingly, the touch screen system may compare the inputted password data to the stored valid password data to determine if the user is a valid user. In one embodiment, the touch screen system described herein may verify password data by comparing a hash of password data to a hash of valid password data.

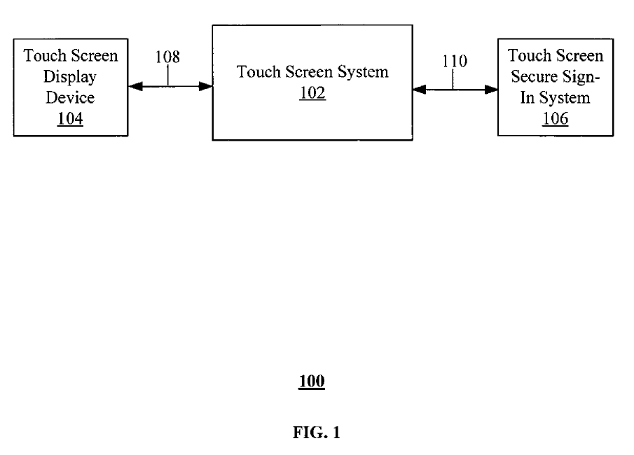

FIG. 1 illustrates a block diagram of a secure sign-in system according to an embodiment of the invention. In one embodiment, the secure sign-in system may include a touch screen display device 104, a touch screen system 102, and a touch screen secure sign-in system 106. The touch screen system 102 may receive password data from the touch screen display device 104 via bidirectional data path 108 and transmit the password data to the touch screen secure sign-in system 106 via bidirectional data path 110. It should be noted that touch screen display device 104, a touch screen system 102, and a touch screen secure-sign in system 106 may be coupled to each other via one or more data paths (e.g., data paths 108 and 110). It should also be noted that touch screen display device 104 and touch screen secure-sign in system 106 may be included in touch screen system 102. It should be noted that the touch screen display device 104, the touch screen system 102, and the touch screen secure sign-in system 106 may be independent of each other or integrally connected to each other.

The touch screen display device 104 may be communicatively coupled to touch screen system 102 via bidirectional data path 108. In one embodiment, the touch screen display device 104 may include software, hardware, or a combination of both, configured to receive input data from a user using one or more touch screen mechanisms. For example, touch screen display device 104 may receive password data, valid password data, or any other data from the user via the one or more touch screen mechanisms. In another embodiment, the touch screen display device 104 may include software, hardware, or a combination of both, configured to transmit data received (e.g., password data, valid password data) by the touch screen system 102 or the touch screen secure sign-in system 106 via data path 108. In yet another embodiment, the touch screen display device 104 may include software, hardware, or a combination of both, configured to display electronic content (e.g., electronic newspapers, electronic magazines). For example, touch screen display device 104 may include an electrophoretic display (EPD), such as an EPD created based on technology developed by the E Ink Corporation of Cambridge, Mass.

The touch screen system 102 may be communicatively coupled to the touch screen display device 104 via bidirectional data path 108 and touch screen secure sign-in system 106 via bidirectional data path 110. In one embodiment, the touch screen system 102 may include software, hardware, or a combination of both, configured to receive password data, valid password data, or any other data from touch screen display device 104 and transmit the password data or valid password data to touch screen secure-sign in system 106.

In another embodiment, the touch screen system 100 may include software, hardware, or a combination of both, configured to receive, process, and facilitate display of electronic content. For example, the touch screen system 100 may be a reader device configured to perform one or more functionalities described in U.S. patent application Ser. No. 12/248,331 entitled “Media Display Device And Method Of Operation Thereof,” filed on Oct. 9, 2008, which is incorporated by reference herein in its entirety. In another example, the touch screen system 100 may be a reader device configured to perform one or more functionalities described in U.S. patent application Ser. No. 12/332,860 entitled “Touch-Sensitive Illuminated Display Apparatus And Method Of Operation Thereof,” filed on Dec. 11, 2008, which is incorporated by reference herein in its entirety.

The touch screen secure sign-in system 106 may be communicatively coupled to the touch screen system 102 and the touch screen display device 104 via bidirectional data path 110. The touch screen secure sign-in system 106 may include software, hardware, or a combination of both, configured to receive password data, valid password data, or any other data from touch screen display device 104 or touch screen system 102. The touch screen secure sign-in system 106 may include software, hardware, or a combination of both configured to determine if a user is a valid user (e.g., authorized user) and allow valid user access to one or more functions of the touch screen system 102. The touch screen secure sign-in system 106 is described in further detail below.

One or more data paths disclosed herein may include any device that communicatively couples one or more devices to each other. For example, one or more data paths may include one or more networks or one or more conductive wires (e.g., copper wires). Data paths 108, 110 are illustrated as bidirectional for illustration purposes. It should be noted that one or more data paths illustrated in FIG. 1 may be unidirectional or bidirectional.

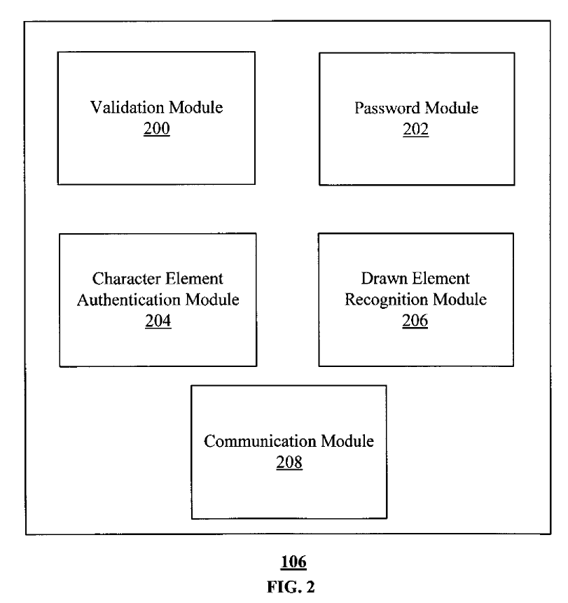

FIG. 2 illustrates exemplary modules of a touch screen secure sign-in system according to an embodiment of the invention. In an exemplary embodiment, the touch screen secure sign-in system 106 may include a validation module 200, a password module 202, a character element authentication module 204, a drawn element recognition module 206, and a communication module 208. It is noted that the modules 200, 202, 204, 206 and 208 are exemplary. The functions of the modules 200, 202, 204, 206 and 208 may be performed at other modules remote or local to the touch screen secure sign-in system 106, and the modules 200, 202, 204, 206 and 208 may be combined or separated.

The communication module 208 may include software, hardware, or a combination of both, configured to receive the valid password data and the password data from the touch screen display device 104 or the touch screen system 102 via data path 110. In one embodiment, the communication module 208 may be configured to communicate the valid password data and the password data received to one or more other modules of the touch screen secure sign-in system 106, such as: the validation module 200, the password module 202, the character element authentication module 204, and the drawn element recognition module 206. In one embodiment, the communication module 208 may be configured to communicate one or more messages received from the other modules to one or more other modules.

The password module 202 may include software, hardware, or a combination of both, configured to allow a valid user to create a valid password during an initial sign-in stage using the touch screen display device 104. In one embodiment, the password module 202 may allow a valid user to begin creating a valid password by selecting an input format (e.g., a valid format) that includes an arrangement of character element data, drawn element data, or a combination of both, according to one or more password format rules.

In one embodiment, a password format rule may define a valid format of a password as a drawn element portion. In another embodiment, a password format rule may define a valid format of a password as a drawn element first portion and a character element second portion. In another embodiment, a password format rule may define a valid format of a password as a character element first portion and a drawn element second portion. In another embodiment, a password format rule may define a valid format of a password as a character element first portion, a drawn element second portion, and a character element third portion. In another embodiment, a password format rule may define a valid format of a password as a drawn element first portion, a character element second portion, and a drawn element third portion. It should be noted that other password format rules that define other valid formats may also be used.

The password module 202 may include software, hardware, or a combination of both, configured to store a valid format that is associated with a valid password. For example, based on a user's selection of a valid format, the password module 202 may store a valid format that includes a character element first portion (e.g., a portion of a password that includes a combination of symbols, numbers, and upper and lower case letters) and a drawn element second portion (e.g., a portion of a password that includes any, or a combination, of one or more free-form drawings, one or more drawn objects, one or more signatures).

In one embodiment, the password module 202 may allow a valid user to continue creating a valid password by inputting valid password data during the initial sign-in stage using the touch screen display device 104. Valid password data may include valid character element data, valid drawn element data, or a combination of both, that is inputted in accordance with the valid format. For example, the password module 202 may be configured to receive and store valid password data that includes character element data (e.g., a password, such as “Billybob232”) followed by drawn element data (e.g., a password, such as a hand drawn circle) in accordance with a first valid format defined as a character element first portion and a drawn element second portion. In another example, the password module 202 may be configured to receive and store valid password data that includes drawn element data (e.g., a password, such as a hand drawn square) followed by character element data (e.g., a password, such as “$unshine”) followed by additional drawn element data (e.g., a password, such as a hand drawn star) in accordance with a second valid format defined as a drawn element first portion, a character element second portion, and a drawn element third portion. In yet another example, the password module 202 may be configured to receive and store valid password data that includes drawn element data (e.g., a password, such as a hand drawn signature) in accordance with a third valid format defined as a drawn element portion.

In one embodiment, the password module 202 may be configured to detect, receive, and store one or more input characteristics associated with one or more drawn element data portions of the valid password data during the initial sign-in stage. An input characteristic may indicate one or more traits of drawn element data. For example, an input characteristic may indicate a path direction characteristic, such as an approximation of a path taken by a user while drawing (e.g., inputting) a drawn element using the touch screen display device 104. In another example, an input characteristic may indicate a path acceleration characteristic, such as an approximation of the manner in which a user accelerates while drawing a drawn element using the touch screen display device 104.

Input characteristics may be used to provide an additional authentication layer such that the input characteristics of the password data received are compared to the pre-stored valid input characteristics. If, for example, one or more input characteristics associated with the password data received is determined to be the same as the one or more valid input characteristics, password module 202 may transmit a data signal that indicates that the password data is valid to the validation module 200. If, however, one or more input characteristics associated with the password data received is not determined to be the same as the one or more valid input characteristics, password module 202 may transmit a data signal that indicates that the password data is not valid to the validation module 200.

In one embodiment, the password module 202 may be configured to transmit valid character element data to the character element authentication module 204 to enable character element authentication. In another embodiment, the password module 202 may be configured to transmit valid drawn element data to the drawn element recognition module 206 to enable drawn element recognition.

After the initial sign-in stage, password module 202 may be configured to receive password data from a user using the touch screen display device 104. In one embodiment, the password module 202 may compare the input format of the received password data to the pre-stored or predefined valid format. If, for example, the input format of the received password data is not the same as the valid format, the password module 202 may output an authentication error message (e.g., “You Have Used The Wrong Password Format! Please Try Again!”) to the user via the touch screen display device 104. If, however, the input format of the received password data is the same as the as the valid format, the password module 202 may initiate authentication techniques, recognition techniques, or a combination of both (using the character element authentication module 204 or the drawn element recognition module 206), to determine if the user is valid.

The character element authentication module 204 may include software, hardware, or a combination of both, configured to receive and store valid character element data that is associated with valid password data. The character element authentication module 204 may include software, hardware, or a combination of both, configured to receive and compare character element data associated with password data to valid character element data. If, for example, the character element data is the same as the valid character element data, character element authentication module 204 may transmit a data signal that indicates that the character element data is valid to the validation module 200. If, however, the character element data is not the same as the valid character element data, character element authentication module 204 may output an authentication error message to the user via the touch screen display device 104.

The drawn element recognition module 206 may include software, hardware, or a combination of both, configured to receive and store valid drawn element data that is associated with valid password data. The drawn element recognition module 206 may include software, hardware, or a combination of both, configured to receive and compare drawn element data associated with password data to valid drawn element data. In one embodiment, the drawn element recognition module 206 may be configured to compare the drawn element data to the valid drawn element data using any, or a combination, of pattern recognition technology (e.g., software or hardware that recognizes inputted data as being a pattern of one or more objects), signature recognition technology (e.g., software or hardware that recognizes inputted data as being approximately the same as pre-stored signature data), and hand writing recognition technology (e.g., software or hardware that recognizes inputted data as being associated with a particular user's handwriting).

In one embodiment, the drawn element recognition module 206 may determine whether the drawn element data is the same as the valid drawn element data in accordance with one or more recognition rules. A recognition rule may indicate the amount of exactness between the received drawn element data and the valid drawn element data that is necessary to be determined to be the same. For example, a recognition rule may indicate the amount of exactness in the placement of a drawn element on one or more drawing grids (e.g., a drawing plane on the screen of a touch screen device) of the touch screen display device 104. In another example, a recognition rule may indicate the amount of exactness of the size of a drawn element on one or more drawing grids of the touch screen display device 104. In yet another example, a recognition rule may indicate the amount of exactness of the proportion of a drawn element on one or more drawing grids of the touch screen display device. In one embodiment, the amount of exactness necessary for drawn element data and valid drawn element data to be determined to be the same may be less for valid passwords that are complex (e.g., passwords that include intricate shapes, passwords that include intricate free-form drawings). It should be noted that the recognition rules may be defined by the implementers of the touch screen secure sign-in system 106 in accordance with design preferences.

In one embodiment, the amount of exactness may be measured or determined in accordance with the signature recognition technology described in U.S. Pat. No. 6,985,610 to Suchard et al., in which a signature recognition and authentication scheme that employs unsupervised neural networks to act on vectors in high dimensional space is disclosed. In another embodiment, the amount of exactness may be measured or determined in accordance with the space curve recognition technology described in U.S. Pat. No. 6,571,173 to Joshi, in which a method of measuring how closely one three-dimensional space curve matches another three-dimensional space curve is disclosed. In such embodiments, the third dimension may be time and the first and second dimensions may be area. In another embodiment, the amount of exactness may be measured or determined in accordance with the pattern recognition screen login technology created by Google, Inc. of Mountain View, Calif.

If, for example, the drawn element data is determined to be the same as the valid drawn element data, drawn element recognition module 206 may transmit a data signal that indicates that the drawn element data is valid to the validation module 200. If, however, the drawn element data is not determined to be the same as the valid drawn element data, drawn element recognition module 206 may output an authentication error message to the user via the touch screen display device 104.

The validation module 200 may include software, hardware, or a combination of both, configured to provide a valid user with access to one or more functions of the touch screen system 102. In one embodiment, the validation module 200 may provide a valid user with access to one or more functions of the touch screen system 102 after receiving one or more data signals that indicate that the password data received is at least approximately the same as the valid password data. In another embodiment, the validation module 200 may provide a valid user with access to one or more functions of the touch screen system 102 after receiving one or more data signals that indicate that the one or more input characteristics associated with the password data received is at least approximately the same as one or more valid input characteristics.

In one embodiment, the validation module 200 may be configured to provide a valid user with access to one or more functions of the touch screen system 102 by disabling one or more locking features (e.g., an authentication locking feature) of the touch screen system 102.

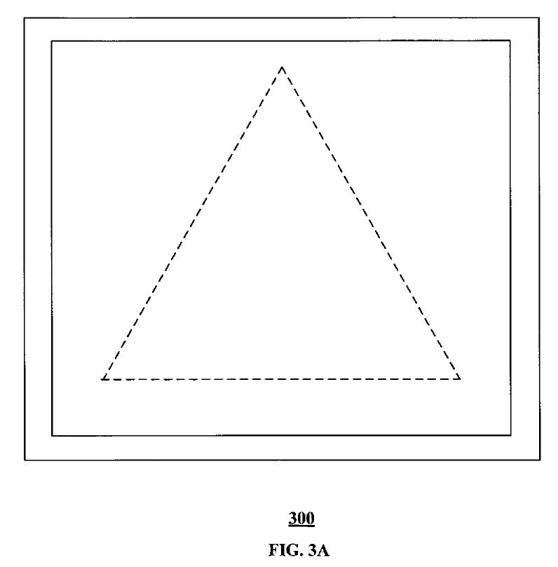

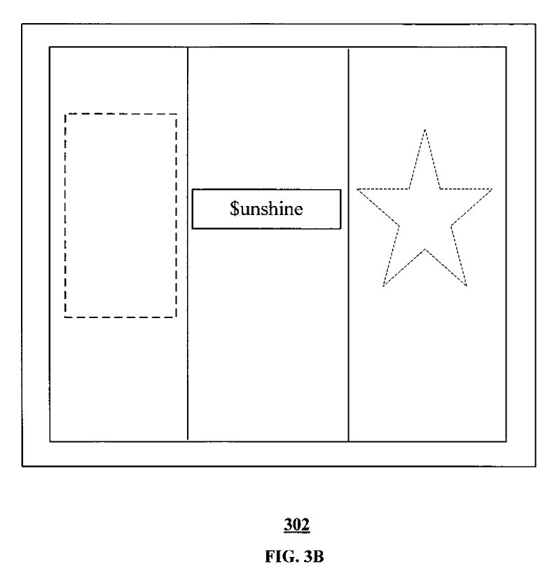

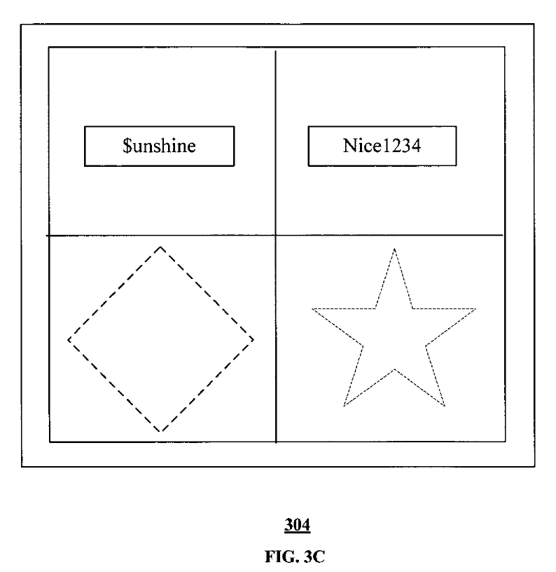

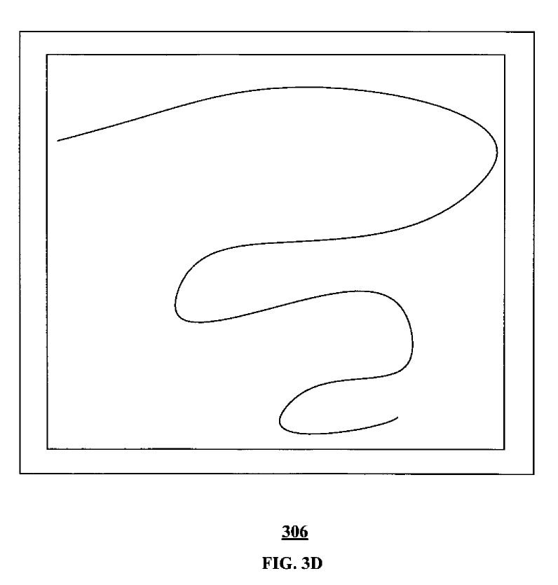

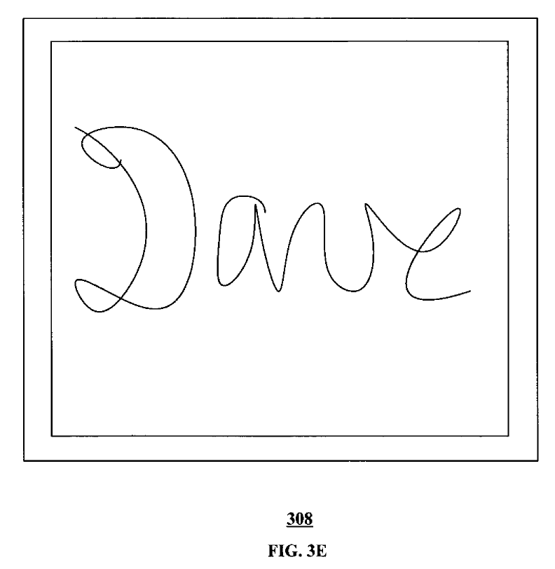

FIG. 3A illustrates exemplary password data according to an embodiment of the invention. By way of non-limiting example, a valid format associated with valid password data of FIG. 3A may be defined as a drawn element portion. Further, valid drawn element data of the valid password data may include a hand drawn triangle shape. Accordingly, a user may hand draw a triangle shape (e.g., password data) using the touch screen display device 104 to gain access to one of more functions of the touch screen system 102.

If, for example, the user fails to draw a triangle shape that is sufficiently similar to the valid password data, the touch screen secure sign-in system 106 may display an authentication error message to the user using the touch screen display device 104. If, however, the user draws a triangle shape that is sufficiently exact to the valid password data, the touch screen secure sign-in system may allow the user to access one or more functions of the touch screen system 102.

FIG. 3B illustrates additional exemplary password data according to an embodiment of the invention. By way of non-limiting example, a valid format associated with valid password data of FIG. 3B may be defined as a drawn element first portion, a character element second portion, and a drawn element third portion. Further, valid drawn element data of the valid password data may include a hand drawn rectangle shape and a hand drawn star shape. Even further, valid character element data of the valid password data may include the password “$unshine.” Accordingly, a user may: (1) hand draw a rectangle shape; (2) input the password “$unshine”; and (3) hand draw a star shape using the touch screen display device 104 to gain access to one of more functions of the touch screen system 102.

If, for example, the user fails to input password data that is determined to be the same as the valid password data, the touch screen secure sign-in system 106 may display an authentication error message to the user using the touch screen display device 104. If, however, the user inputs password data that is determined to be the same as the valid password data, the touch screen secure sign-in system may allow the user to access one or more functions of the touch screen system 102.

FIG. 3C illustrates additional exemplary password data according to an embodiment of the invention. By way of non-limiting example, a valid format associated with valid password data of FIG. 3C may be defined as a character element first portion, a character element second portion, a drawn element third portion, and a drawn element fourth portion. Further, valid character element data of the valid password data may include the password “$unshine” and “Nice1234.” Even further, valid drawn element data of the valid password data may include a hand drawn diamond shape and a hand drawn star shape. Accordingly, a user may: (1) input the password “$unshine”; (2) input the password “Nice1234”; (3) hand draw a diamond shape; and (4) hand draw a star shape using the touch screen display device 104 to gain access to one of more functions of the touch screen system 102.

If, for example, the user fails to input password data that is determined to be the same as the valid password data, the touch screen secure sign-in system 106 may display an authentication error message to the user using the touch screen display device 104. If, however, the user inputs password data that is determined to be the same as the valid password data, the touch screen secure sign-in system may allow the user to access one or more functions of the touch screen system 102.

FIG. 3D illustrates additional exemplary password data according to an embodiment of the invention. By way of non-limiting example, a valid format associated with valid password data of FIG. 3D may be defined as a drawn element portion. Further, valid drawn element data of the valid password data may include a hand drawn free-form shape. Accordingly, a user may hand draw the free-form shape illustrated in FIG. 3D using the touch screen display device 104 to gain access to one of more functions of the touch screen system 102.

If, for example, the user fails to draw a free-form shape that is sufficiently similar to the valid password data, the touch screen secure sign-in system 106 may display an authentication error message to the user using the touch screen display device 104. If, however, the user draws a free-form shape that is sufficiently exact to the valid password data, the touch screen secure sign-in system may allow the user to access one or more functions of the touch screen system 102.

FIG. 3E illustrates additional exemplary password data according to an embodiment of the invention. By way of non-limiting example, a valid format associated with valid password data of FIG. 3E may be defined as a drawn element portion. Further, valid drawn element data of the valid password data may include a hand drawn signature shape. Accordingly, a user may hand draw the signature shape illustrated in FIG. 3E using the touch screen display device 104 to gain access to one of more functions of the touch screen system 102.

If, for example, the user fails to draw a signature shape that is sufficiently similar to the valid password data, the touch screen secure sign-in system 106 may display an authentication error message to the user using the touch screen display device 104. If, however, the user draws a signature shape that is sufficiently exact to the valid password data, the touch screen secure sign-in system may allow the user to access one or more functions of the touch screen system 102.

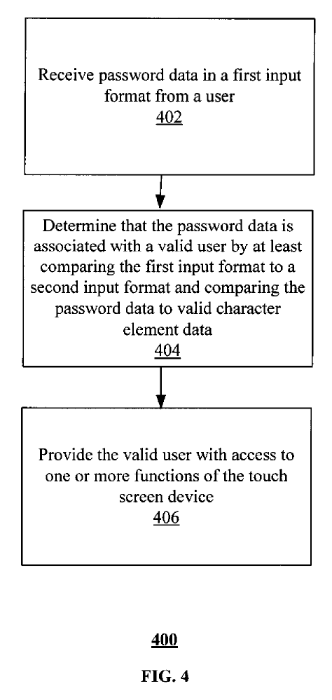

FIG. 4 is a flow chart illustrating a method of providing secure sign-in on a touch screen device according to an embodiment of the invention. This exemplary method is provided by way of example, as there are a variety of ways to carry out methods disclosed herein. The method shown in FIG. 4 can be executed or otherwise performed by one or a combination of various systems. The method is described below as carried out by the touch screen secure sign-on system 106 shown in FIG. 1 by way of example, and various elements of the touch screen secure sign-on system 106 are referenced in explaining the example method of FIG. 4. Each block shown in FIG. 4 represents one or more processes, methods, or subroutines carried in the exemplary method 400. Referring to FIG. 4, the exemplary method 400 may begin at block 402.

In block 402, the method 400 may include receiving password data in a first input format from a user. In one embodiment, the password module 202 of the touch screen secure sign-in system 106 may receive password data in a first input format from a user via data path 110. The method 400 may continue to block 404.

In block 404, the method 400 may include determining that the password data is associated with a valid user by at least comparing the first input format of the password data to a second input format and comparing the password data to valid character element data. In one embodiment, the password module 202 of the touch screen secure sign-in system 106 may determine that the password data is associated with a valid user by at least comparing the first input format of the password data to a second input format and comparing the password data to valid character element data. The method 400 may continue to block 406.

In block 406, the method 400 may include providing the valid user with access to one or more functions of the touch screen device. In one embodiment, the validation module 200 of the touch screen secure sign-in system 106 may providing the valid user with access to one or more functions of the touch screen device. The method 400 may then end.

The description above describes systems, networks, and reader devices, that may include one or more modules, some of which are explicitly shown in the figures. As used herein, the term “module” may be understood to refer to any, or a combination, of computer executable computing software, firmware, and hardware. It is noted that the modules are exemplary. The modules may be combined, integrated, separated, or duplicated to support various applications. Also, a function described herein as being performed at a particular module may be performed at one or more other modules or by one or more other devices instead of or in addition to the function performed at the particular module. Further, the modules may be implemented across multiple devices or other components local or remote to one another. Additionally, the modules may be moved from one device and added to another device, or may be included in multiple devices.

It is further noted that the software described herein may be tangibly embodied in one or more physical media, such as, but not limited to any, or a combination, of a compact disc (CD), a digital versatile disc (DVD), a floppy disk, a hard drive, read only memory (ROM), random access memory (RAM), and other physical media capable of storing software. Moreover, the figures illustrate various components (e.g., systems, networks, and reader devices) separately. The functions described as being performed at various components may be performed at other components, and the various components may be combined or separated. Other modifications also may be made.

In the instant specification, various exemplary embodiments have been described with reference to the accompanying drawings. It will, however, be evident that various modifications or changes may be made thereto, or additional embodiments may be implemented, without departing from the broader scope of the invention as set forth in the claims that follow. The specification and drawings are accordingly to be regarded in an illustrative rather than a restrictive sense.

1. A computer-implemented method of providing secure sign-in on a touch screen device that comprises an electronic device, the computer-implemented method comprising:
receiving, from a user, password data in a first input format;
determining that the password data is associated with a valid user by at least comparing the first input format of the password data to a second input format and comparing the password data to valid character element data, wherein the second input format is derived in accordance with one or more password format rules; and
providing the valid user with access to one or more functions of the touch screen device.

2. The computer-implemented method of claim 1, wherein the password data comprises at least one of character element data and drawn element data.

3. The computer-implemented method of claim 2, wherein the drawn element data comprises at least one of free-form data, object data, and signature data.

4. The computer-implemented method of claim 1, wherein the second input format comprises a valid format.

5. The computer-implemented method of claim 4, wherein the one or more password format rules are selected from a group consisting of: (1) the valid format comprises a drawn element portion; (2) the valid format comprises a drawn element first portion and a character element second portion; (3) the valid format comprises a character element first portion and a drawn element second portion; (4) the valid format comprises a character element first portion, a drawn element second portion, and a character element third portion; and (5) the valid format comprises a drawn element first portion, a character element second portion, and a drawn element third portion.

6. The computer-implemented method of claim 1, wherein determining that the password data is associated with the valid user further comprises comparing the password data to valid drawn element data.

7. The computer-implemented method of claim 1, further comprising storing one or more input characteristics that are associated with the password data.

8. The computer-implemented method of claim 7, wherein the one or more input characteristics comprise at least a path direction characteristic and a path acceleration characteristic.

9. The computer-implemented method of claim 7, wherein determining that the password data is associated with the valid user further comprises comparing the one or more input characteristics to one or more valid input characteristics.

10. The computer-implemented method of claim 1, wherein providing the valid user with access to one or more functions of the touch screen device further comprises disabling one or more locking features of the touch screen device.

11. A computer-implemented system for providing secure sign-in on a touch screen device that comprises an electronic device, the computer-implemented system comprising:
a password computing apparatus configured to receive, from a user, password data in a first input format and determine that the password data is associated with a valid user by at least comparing the first input format of the password data to a second input format, wherein the second input format is derived in accordance with one or more password format rules;
a character element authentication computing apparatus configured to determine that the password data is associated with the valid user by comparing the password data to valid character element data; and
a validation computing apparatus configured to provide the valid user with access to one or more functions of the touch screen device.

12. The computer-implemented system of claim 11, wherein the password data comprises at least one of character element data and drawn element data.

13. The computer-implemented system of claim 12, wherein the drawn element data comprises at least one of free-form data, object data, and signature data.

14. The computer-implemented system of claim 11, wherein the second input format comprises a valid format.

15. The computer-implemented system of claim 14, wherein the one or more password format rules are selected from a group consisting of: (1) the valid format comprises a drawn element portion; (2) the valid format comprises a drawn element first portion and a character element second portion; (3) the valid format comprises a character element first portion and a drawn element second portion; (4) the valid format comprises a character element first portion, a drawn element second portion, and a character element third portion; and (5) the valid format comprises a drawn element first portion, a character element second portion, and a drawn element third portion.

16. The computer-implemented system of claim 11, wherein a drawn element recognition computing apparatus is further configured to determine that the password data is associated with the valid user by comparing the password data to valid drawn element data.

17. The computer-implemented system of claim 11, wherein the password computing apparatus is further configured to store one or more input characteristics that are associated with the password data.

18. The computer-implemented system of claim 17, wherein the one or more input characteristics comprise at least a path direction characteristic and a path acceleration characteristic.

19. The computer-implemented system of claim 17, wherein the password element recognition computing apparatus is configured to determine that the password data is associated with the valid user by comparing the one or more input characteristics to one or more valid input characteristics.

20. The computer-implemented system of claim 11, wherein the validation computing apparatus is further configured to provide the valid user with access to one or more functions of the touch screen device by disabling one or more locking features of the touch screen device.
